(19) United States
(12) Patent Application Publication
(10) Pub. No.: US 2003/0091311 A1
(43) Pub. Date: May 15, 2003

(54) Planar waveguide facet profiling

(75) Inventors: Yee Loy Lam, Singapore (SG); Woon Loong Daniel Leong, Singapore (SG); Yuen Chuen Chan, Singapore (SG)

Correspondence Address: BEYER WEAVER & THOMAS LLP, P.O. BOX 778, BERKELEY, CA, 94704-0778, US

(73) Assignee: Denselight Semiconductors Pte Ltd

(21) Appl. No.: 10/272,217

(22) Filed: Oct. 16, 2002

(30) Foreign Application Priority Data
Oct. 16, 2001 (GB) 0124845.9

(51) Int. Cl. G02B 6/10; G02B 6/26

(52) U.S. Cl. 385/129; 385/31

(57) ABSTRACT

In the present invention, profiling of the end facet of an optical waveguide reduces the amount of reflected light propagating in the waveguide. In a conventional waveguide, the effective reflectivity experienced by light at a facet is determined by the modal content of the light and the refractive index of the waveguide (core and cladding) and other material at either side of the dielectric interface, which constitutes the facet. In the present invention, depending upon the modal content of the light, the waveguide dimensions and the refractive indices at the dielectric interfaces, we adjust the profile of the facets so that it is no longer planar and so substantially reduce the amount of reflected light propagating back along the waveguide. This reduction in “effective reflectivity” can be due to an increase in the loss experienced by any reflected light or due to an increase in the amount of light transmitted.

### FIELD OF THE INVENTION

The present invention relates to controlling the effective reflectivity of a facet at a dielectric interface by means of its profile, and in particular the end facet of an optical waveguide structure.

### BACKGROUND TO THE INVENTION

There are many occasions where it is highly desirable to achieve a low effective reflectivity at the facet of a semiconductor light source, such as a laser diode (LD) or a superluminescent diode (SLD). For example, a low reflectivity at the output facet of an LD may be desired in order to couple more light out of the laser cavity whilst still ensuring efficient laser oscillation. However, optical cavity oscillations are undesirable in low coherence light sources, such as an SLD, which emit mainly amplified spontaneous light. The oscillations are caused by light reflecting from the facets of the light source, and therefore to eliminate oscillations and maintain low coherence, it is important to reduce significantly the reflectivity of one or both facets.

A common practice used to control facet reflectivity in such devices, is to apply a low reflectivity or anti-reflective (AR) coating to the facet of a waveguide. Another common practice is to angle the facet such that light is reflected in a direction that does not allow it to easily propagate towards the other facet, as described in Lin C. -F., “Superluminescent diodes with angled facet etched by chemically assisted ion beam etching”, Electron. Lett., Vol. 27(11), 1991. Alternatively, to achieve the same result, the waveguide can be oriented at an angle with respect to the direction of propagation of light in the waveguide as described by Alphonse G. A., et al, “High-power superluminescent diodes”, IEEE J. Quantum Electron., Vol. 24(12), 1988, or may comprise a bent section as proposed in Lin C. -F., et al, “Superluminescent diodes with bent waveguide”, IEEE Photonics Technol. Lett., Vol. 8(2), 1996.

Adjusting the facet reflectivity by use of an AR coating requires stringent control of the refractive index and thickness of the coating, making good quality reproducible coatings of very low reflectivity difficult to achieve. A poor AR coating may suffice for a low reflectivity requirement, but it still needs to be sufficiently uniform. To achieve very low reflectivity, the AR coating should consist of multiple layers, which further complicates the coating process. An additional problem is the relatively small bandwidth associated with coatings comprising multiple layers of dielectric materials, the useful bandwidth typically reducing as the coating complexity increases.

In an active device requiring very low effective facet reflectivity, such as an SLD, tilting the waveguide stripe or facets with respect to the direction of light propagation is effective in controlling the reflectivity. However, the optical beams emerging from such waveguides are typically asymmetric and more divergent than from a conventional waveguide design, which complicates the subsequent coupling of the light into other optical components, such as optical fibres or modulators, and reduces the overall efficiency of the optical system. Furthermore, this approach often results in an inefficient optical device as light is emitted from both facets of the device although only light from one facet is used for coupling to a fibre or for free space applications.

### SUMMARY OF THE INVENTION

In the present invention, profiling of the end facet of an optical waveguide reduces the amount of reflected light propagating in the waveguide.

If the waveguide is such that light is substantially confined in one transverse dimension, a planar waveguide for example, the facet will be profiled in that dimension. If the waveguide is such that light is substantially confined in both transverse dimensions, a rectangular waveguide for example, the facet will be profiled in both these dimensions. Of course, the profile of the facet may be different in the two dimensions.

In a conventional waveguide the effective reflectivity experienced by light at a facet, is determined by the modal content of the light, and the refractive index of both the waveguide material (core and cladding) and the material on the other side of the dielectric interface, which constitutes the facet. The light reflected from a planar facet comprises the same modal content as the light which is incident, and therefore supported by the waveguide.

Depending upon the modal content of the light, the waveguide dimensions and the refractive indices at the dielectric interface, changes to the profile of a facet, such that it is no longer planar, can substantially reduce the amount of reflected light propagating back along the waveguide. This reduction in “effective reflectivity” can be due to an increase in the loss experienced by any reflected light or due to an increase in the amount of light transmitted.

The first approach, of increasing the loss experienced by light reflected at a facet, can be achieved by employing a type of facet profiling that we term a mode re-launcher (MRL). The MRL comprises a facet with a profile that re-launches much of the reflected light into higher order modes that are only weakly supported by the waveguide. Light in these higher order modes will typically couple into the waveguide cladding on both sides and thereby leak out of the waveguide structure, preventing it from reaching the other facet.

Preferably, the MRL comprises a facet profile which couples a substantial fraction of any reflected light into higher order modes that are substantially unconfined by the waveguide structure.

Careful choice of facet profile allows a desired level of low effective reflectivity to be achieved. Typically, the profile of the MRL facet will be symmetric about its centre, with each half described by a monotonic functional form. For example, the profile of the facet may comprise an arc of a circle or cosinusoid, although many other shapes are possible.

The second approach, of increasing the amount of light transmitted at a facet, can be achieved by employing a type of facet profiling that we term a mode radiator (MRA). The MRA comprises a facet with a profile which causes a substantial part of any reflected light to destructively interfere in the waveguide, due to its relative phasing, thereby leading to an increase in the amount of transmitted light.

Preferably, the MRA comprises a facet profile which couples a substantial fraction of light reflected into the waveguide to destructively interfere.

Typically, the profile of the MRA facet will comprise a periodic structure, or serrations, on a scale comparable with the wavelength of the light.

The waveguide facet may, of course, exhibit features of both the MRL and MRA. For example, the large scale or average shape of the facet may correspond to that of the MRL, whilst the smaller scale structure of the MRA may be superposed.

The shape of the facet will also typically affect the transverse intensity profile of the transmitted beam, in a manner that will be either deleterious or advantageous to the subsequent use of the optical beam, such as coupling into another waveguide device.

Preferably, the profile of the facet has substantially no effect on the transverse intensity profile of the transmitted beam. More preferably, the profile of the facet is such that the transverse intensity profile of the transmitted beam is modified in a manner beneficial to its subsequent usage.

The waveguide facet may be profiled to achieve a low-loss, low-reflectivity output coupler for a semiconductor diode laser or to achieve substantially zero reflectivity for use in a superluminescent diode.

The present invention, also provides an optical or optoelectronic device comprising a waveguide structure, wherein at least one end facet is profiled to reduce the amount of reflected light propagating in the waveguide.

### BRIEF DESCRIPTION OF THE DRAWINGS

Examples of the present invention will now be described in detail with reference to the accompanying drawings, in which:

FIG. 1 shows the distribution of light intensity both inside and outside a stripe waveguide with flat end facet;

FIGS. 2A and 2B are schematic views of a stripe waveguide with one flat facet and one curved facet (the MRL), in accordance with the present invention, and FIG. 2C is a schematic view of an SLD which incorporates this waveguide design;

FIGS. 3 shows the distribution of light intensity both inside and outside the stripe waveguide of FIGS. 2A and 2B;

FIG. 4 is a plot of effective facet reflectivity versus MRL length;

FIG. 5 is a plot of effective facet reflectivity versus wavelength;

FIG. 6 is a plot of effective facet reflectivity versus wavelength;

FIGS. 7A, 7B and 7C are output beam profiles for a waveguide with flat facet, with MRL and with tilted facet, respectively;

FIGS. 8A and 8B are schematic views of a stripe waveguide with one flat facet and one serrated facet (the MRA), in accordance with the present invention;

FIG. 9 shows the distribution of light intensity both inside and outside the stripe waveguide of FIGS. 8A and 8B;

FIG. 10 is a plot of effective facet reflectivity versus wavelength; and,

FIG. 11A and 11B are output beam profiles for a waveguide with flat facet and with an MRA, respectively.

### DETAILED DESCRIPTION

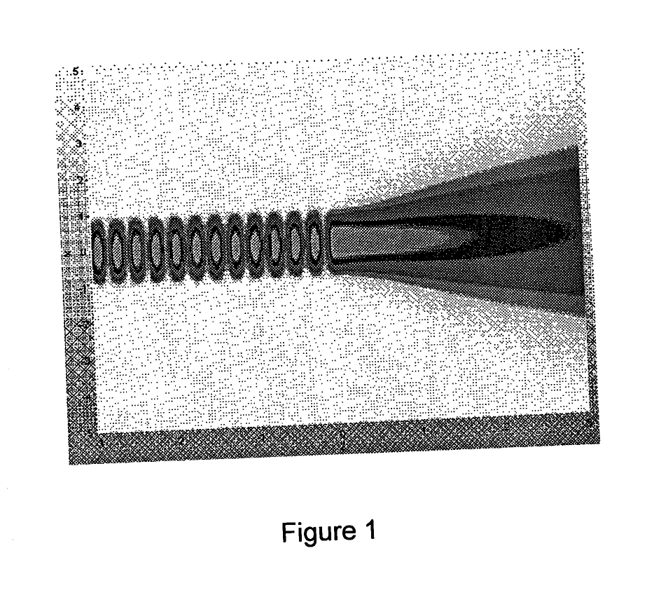

In a conventional rectangular or stripe waveguide with flat planar facets, the modes of the light reflected from the facets are identical to the modes of light propagating along the waveguide. Reflected light therefore remains confined in the waveguide leading to a standing wave pattern with axial nodes and anti-nodes corresponding to the minima and maxima in the light intensity distribution along the waveguide, as shown in the simulation of FIG. 1 for a simple stripe waveguide. The simulation was performed with software from Apollo Photonics Inc., using the Finite-Difference Time-Domain method described in Yee K. S., “Numerical solution of initial boundary value problems involving Maxwell's equations in isotropic media”, IEEE Trans. on Antennas and Propagation, vol. 14, 1966.

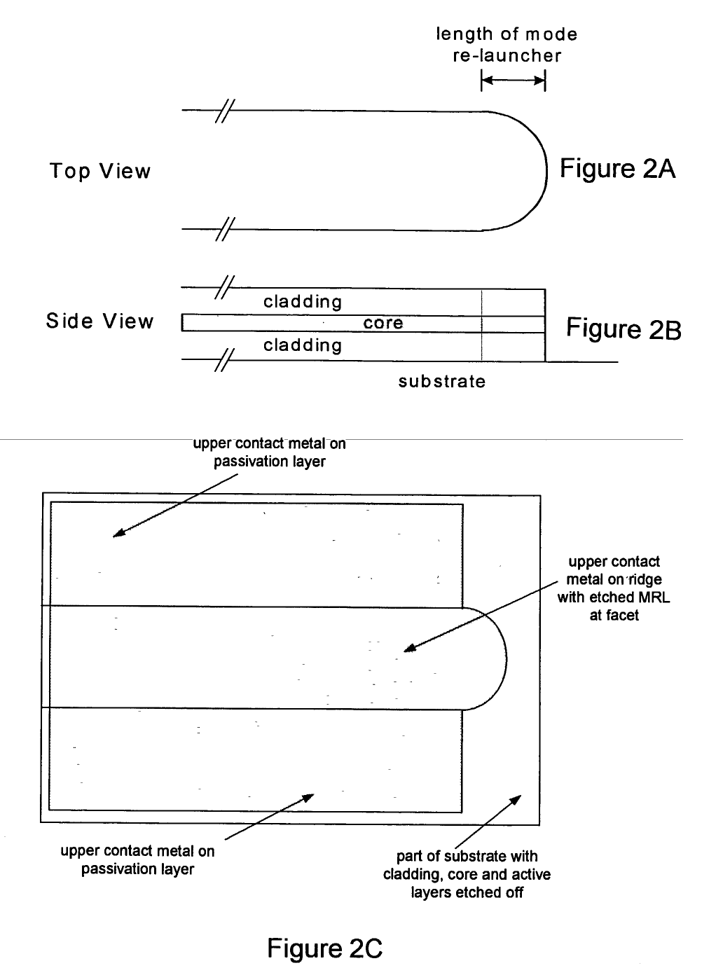

In one embodiment of the present invention, the effect of any reflected light can be minimized by using a non-flat or non-planar facet, which we term a mode re-launcher (MRL). To illustrate the operation of the MRL, we will use, for simplicity, an active waveguide stripe with a flat, reflective or partially reflective facet at one end and an MRL at the other end. A simple plan view and cross-sectional view of the shape of the waveguide core is shown in FIGS. 2A and 2B, respectively. The MRL used here comprises an arc of a cosinusoid, although it is by no means restricted to this shape. Light propagates from the flat facet to the MRL where a portion is reflected and relaunched back into higher, weakly confined modes of the waveguide. FIG. 2C shows an example of an SLD which incorporates an MRL type ridge waveguide structure.

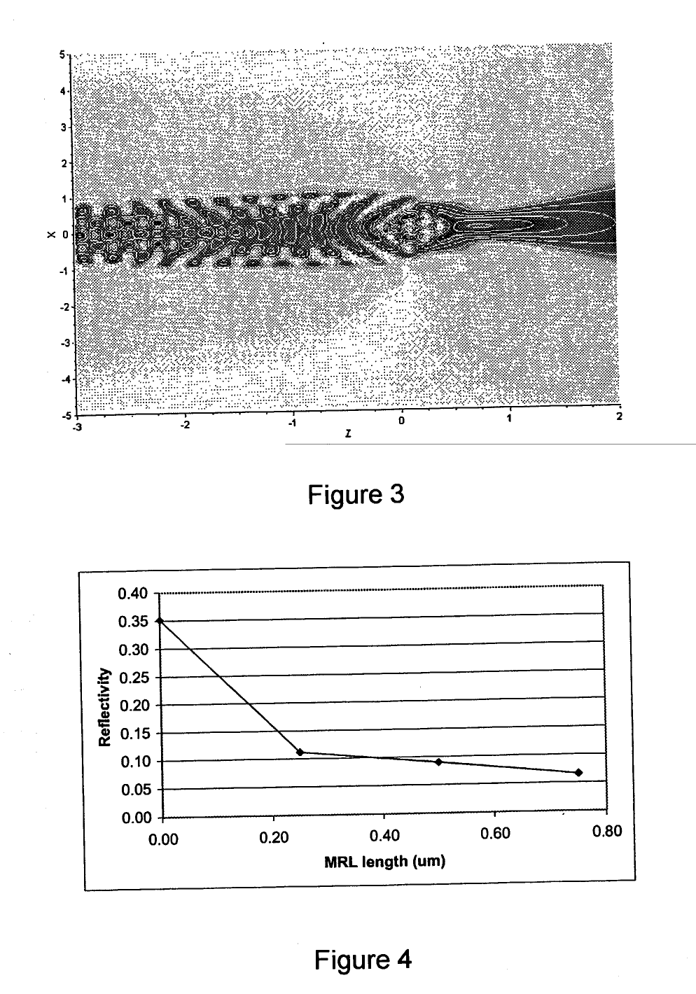

As these higher order modes are more weakly confined to the waveguide they radiate out along the sides of the waveguide, via the side cladding, as shown in the simulation of FIG. 3. Comparison of FIG. 3 with FIG. 1 clearly shows a reduced depth of modulation of the on-axis light intensity distribution, indicating the reduced effect of any reflected light.

The reflected light thus suffers from a loss mechanism which is dependent upon the shape and dimensions of the MRL. Changing the parameters of its shape will alter the effective reflectivity of the MRL. FIG. 4 shows that as the length (in μm) of the MRL (i.e. the longitudinal difference between the centre and the edge of the curved facet) is increased, the effective reflectivity falls, with much of the reduction achievable for this example with only a 0.25 μm MRL. The MRL can be configured for minimum reflection, which is highly desirable for superluminescent diodes, or for a specific low reflectivity in the case of a laser diode.

The effect of refractive index difference between waveguide core and side cladding on the effective reflectivity of the waveguide facet was also investigated. The results of simulations for a planar facet (no MRL), cosinusoidal MRL and circular MRL and for three values of side cladding index (with fixed waveguide core index) are given in Table 1 below. As can be seen, the use of a suitable MRL (cosinusoidal) with a small core-cladding refractive index difference (0.001) can lead to a reduction in the effective reflectivity of more than two orders of magnitude. The role of the small refractive index difference is to lead to weaker optical confinement and therefore greater loss for the high-order reflected modes.

TABLE 1

| | | Reflectivity for λ = 1.55 μm | | |
|---|---|---|---|---|
| Refractive index | | No MRL | Cosine MRL | Circular MRL |
| n(waveguide) | = 3.2 | 0.34 | 0.08 | 0.11 |
| n(cladding) | = 1.0 | | | |
| n(waveguide) | = 3.2 | 0.34 | 0.02 | 0.05 |
| n(cladding) | = 1.5 | | | |
| n(waveguide) | = 3.2 | 0.34 | 0.002 | 0.02 |
| n(cladding) | = 3.199 | | | |

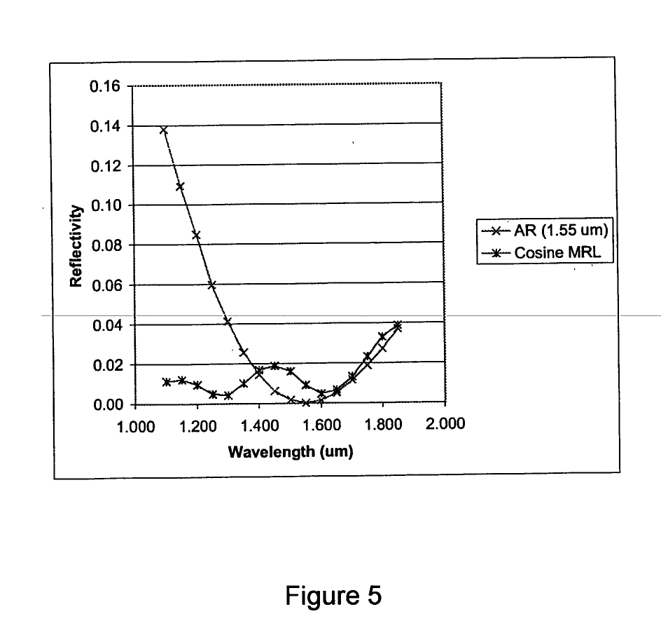

The MRL can also exhibit superior spectral features when compared to other methods for achieving low facet reflectivity. FIG. 5 shows the effective reflectivity spectra of the cosinusoidal MRL and of an AR-coated planar facet, for comparison. It can be seen that although the AR-coated facet has a lower minimum reflectivity at its design wavelength of 1.55 μm, the spectral range over which the reflectivity is below 2% is considerably smaller than that for the MRL.

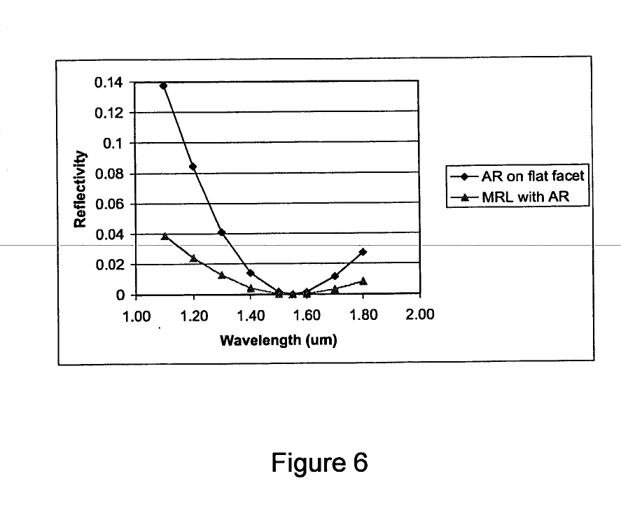

However, by adding an AR coating to the facet of the MRL, it is possible to realize a low reflectivity over a broad spectral range. FIG. 6 shows the reflectivity spectra of an AR-coated planar facet and an AR-coated MRL. The MRL has considerably increased the spectral width over which the AR coating is effective, in addition to reducing the overall reflectivity. To emphasize this behaviour, at the design wavelength of 1.55 μm, Table 2 shows the reflectivity of an uncoated planar facet, an AR-coated planar facet, an MRL and an AR-coated MRL. The AR-coated MRL leads to an order of magnitude reduction in reflectivity as compared to the simple AR-coated planar facet.

TABLE 2

| Reflector | Reflectivity for λ = 1.55 μm |
|---|---|
| Bare flat facet | 0.33871 |
| AR coating | 0.00021 |
| MRL | 0.00920 |
| AR on MRL | 0.00002 |

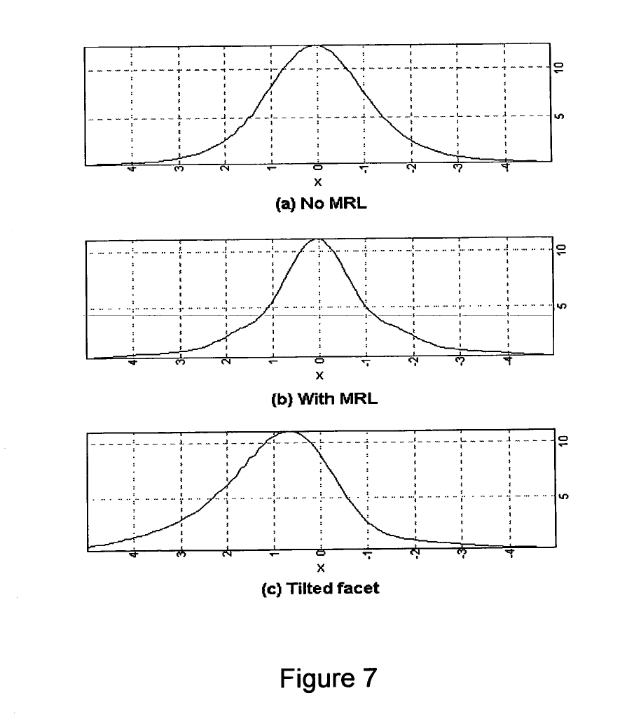

It is often the case that the output from an active stripe waveguide is to be coupled into an optical fibre. Therefore, it is desirable that the reflection reducing mechanism does not have a detrimental effect on the transverse beam profile of the transmitted light. For comparison, FIGS. 7A, 7B and 7C show the output beam profiles from waveguides with a planar facet, an MRL and an angled planar facet, respectively. It can be seen that the beam from the MRL is more symmetric than that obtained from an angled facet, and has a narrower width than that from an untilted planar facet, although is less Gaussian. These features can be advantageous for the efficient coupling of the light into a fibre. Thus, in addition to controlling reflectivity, an MRL can be used as a mode or spot size converter.

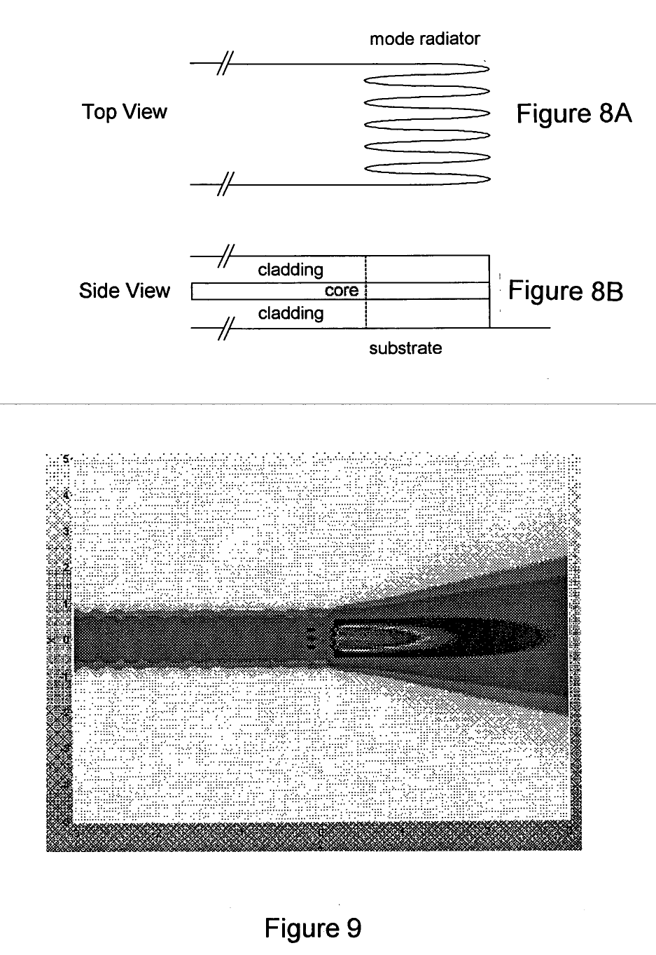

In a second embodiment of the present invention, the amount of light reflected from a waveguide facet can be minimized by using a non-planar facet, which we term a mode radiator (MRA). The MRA comprises a facet with periodic serrations, an example of which is shown in FIGS. 8A and 8B. As described previously, in a conventional stripe waveguide with flat facets, some of the light propagating along the waveguide is reflected back into the waveguide where it remains confined, leading to standing waves along the waveguide axis, as shown in FIG. 1. However, the serrated facet of the MRA causes the relative phase of any reflected light to be such that it experiences destructive interference in the region of the facet, and its intensity is significantly reduced. The overall result is a reduction in the amount of reflected light and a commensurate increase in the amount of transmitted light. The reduced reflectivity leads to reduced standing wave formation in the waveguide, as shown in FIG. 9.

Table 3 below compares the reflectivity of a flat facet with that of an MRA for a device with a refractive index of 3.2 and 1.5 for the waveguide core and side cladding layer, respectively. The MRA has reduced the reflectivity by a significant factor.

TABLE 3

| Facet type | Reflectivity |
|---|---|
| Flat | 0.33871 |
| MRA | 0.00017 |

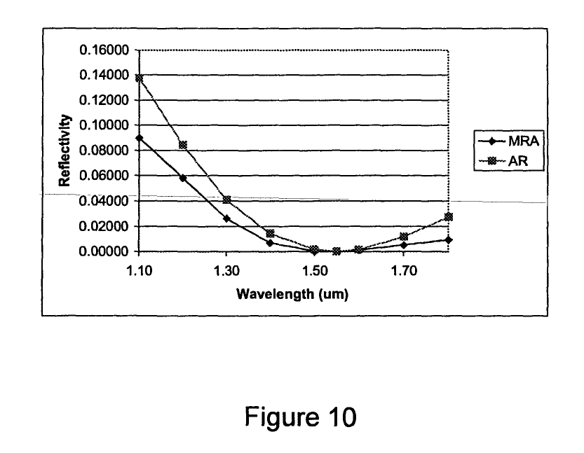

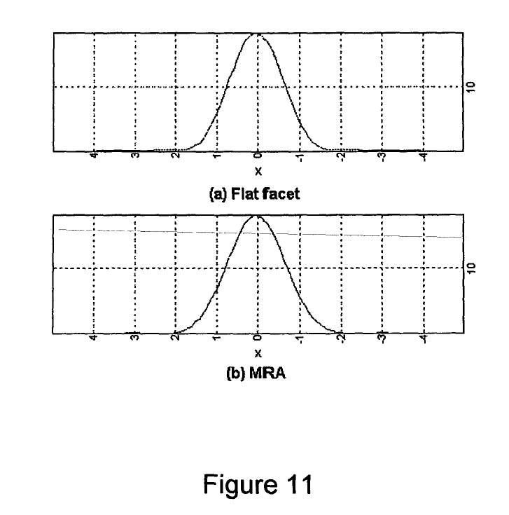

As shown in FIG. 10, the MRA is a broadband device with a minimum reflectivity comparable to that of an antireflection (AR) coated planar facet, whilst achieving a lower reflectivity over a broad range. A further benefit is that the MRA has little effect on the transverse profile of the transmitted beam, as can be seen from FIG. 11, where the profile of a beam transmitted by a flat facet is shown for comparison. The beam from the MRA remains symmetrical and Gaussian, which is advantageous for coupling to an optical fibre.

Thus both embodiments of the present invention, MRL and MRA, share a number of common features, but differ slightly in their mode of operation. The MRL reduces effective facet reflection by relaunching reflected light at higher order modes that are more weakly guided and therefore radiate out from the sides of the waveguide, preventing propagation back to the rear facet. The MRL is also able to modify the mode and spot size of the beam emerging from it, which is advantageous for coupling the light into a fibre. The MRA reduces facet reflection by reflecting light in anti-phase to produce destructive interference and thereby reduced reflectivity. The beam from an MRA is Gaussian, which again is advantageous for coupling the light into a fibre.

The waveguide, which hosts the MRL or MRA, may provide optical confinement in the horizontal dimension by using a ridge, buried structure or gain guiding scheme, while guiding in the vertical dimension can be achieved using abrupt or graded index structures. The optical confinement may also be provided by a circularly symmetric structure such as an optical fibre. The fabrication of a profiled facet, on any of the above waveguide structures, can easily be achieved using standard manufacturing processes and equipment.

Both the MRL and MRA have been shown to be very broadband devices characterized by low reflectivity over a wide wavelength range. The MRL can also be AR-coated to provide a very low reflectivity over a broad bandwidth. The high transmission of the MRA suggests its use in an efficient absorbing device by integrating the MRA facet with an absorbing medium, such as a photo-detecting medium.

Although we have concentrated on the attainment of low reflectivity, the low reflecting facet can be used in concert with a facet of high reflectivity. For example, by applying a high reflectivity (HR) coating to the back facet of an active device and taking the optical output from the front MRL or MRA facet, which may also be AR-coated in the case of the MRL, a highly efficient superluminescent diode (SLD) device can be fabricated.

This technique of facet profiling, for the control of waveguide facet reflectivity, is simple, does not require stringent process control and results in high yield and significant savings in fabrication cost.

The MRL and MRA facet structures can be manufactured through photolithography and semiconductor etching. As an example, firstly the curved profile of the MRL or the serrated profile of the MRA is formed on a photoresist layer that is coated onto the wafer with a dielectric etch-mask. The pattern is then transferred from the photoresist to the dielectric etch-mask by dry plasma etching so that the fine resolution of the profile is preserved. Subsequently, a deep semiconductor etch is carried out by dry plasma etching so that vertical sidewalls can be obtained. Finally, the dielectric etch-mask is removed by wet etching.

The dimensions of the MRL (such as the length of the MRC, as shown in FIG. 2A) and MRA (such as period and maximum swing of serrations shown in FIG. 8A) for optimal anti-reflectivity depend not only on the waveguide width, refractive indices of the waveguide core and side cladding layers, but also on the exact shape of the structure used. Regardless of the shape of the MRL and MRA, or waveguide width and refractive index profile, the MRL and MRA structures control the optical reflectivity by preventing light, to various degrees, from reaching the other facet of the waveguide.

In comparison to some of the other techniques for reducing reflected light, the present invention also facilitates the coupling of light into a fibre, by virtue of its negligible or even beneficial effect on the transmitted beam profile. This would result in savings in packaging costs by widening the coupling tolerances and easing equipment specifications. While the present invention is clearly applicable to devices such as an SLD, a person skilled in the art should be able to extend the applicability of the invention to other waveguide devices, such as passive waveguide devices, semiconductor optical amplifiers, laser diodes, optical modulators, and other forms of planar waveguide devices and circuits.

1. A planar optical waveguide comprising a core region and an adjacent cladding region, the light being coupled into or out of the waveguide by means of a facet at a dielectric interface, wherein the facet has a non-planar profile to reduce the amount of light reflected from the facet and thereafter propagating in the waveguide.

2. An optical waveguide according to claim 1, in which light is confined in one transverse dimension, the waveguide facet being profiled in that dimension.

3. An optical waveguide according to claim 1, in which light is confined in two transverse dimensions, the waveguide facet being profiled in at least one of the two dimensions.

4. An optical waveguide according to any of claims 1 to 3, in which a substantial portion of light reflected into the waveguide from the facet is launched into higher order modes of the waveguide, the higher order modes being substantially unconfined by the waveguide and therefore coupling out of the waveguide via the cladding.

5. An optical waveguide according to any of claims 1 to 3, in which a substantial portion of light reflected into the waveguide from the facet destructively interferes, thereby increasing the transmission of light by the facet.

6. An optical waveguide according to any preceding claim, wherein the profiled facet acts as a mode or spot size converter in respect of light transmitted by the facet.

7. An optical waveguide according to any preceding claim, in which the spatial profile of the facet is substantially symmetric about an axis of symmetry of the waveguide.

8. An optical waveguide according to claim 7, in which the spatial profile of each half of the facet is described by a monotonic function.

9. An optical waveguide according to any preceding claim, in which the spatial profile of the facet is an arc of one of the following: circle, ellipse, parabola and cosinusoid.

10. An optical waveguide according to any of claims 1 to 7, in which the spatial profile of the facet is described by a periodic function.

11. An optical waveguide according to claim 10, in which a period of the periodic function is comparable with the wavelength of the light confined by the waveguide.

12. An optical waveguide according to claim 10 or claim 11, in which the periodic function is a cosinusoid.

13. An optical waveguide according to any preceding claim, in which the profiled facet is anti-reflection coated.

14. An optical device comprising an optical waveguide according to any preceding claim.

15. An optical device according to claim 14, wherein the optical device is selected from one of the following: laser diode, superluminescent diode, optical amplifier and optical modulator.
